(19) United States
(12) Patent Application Publication
(10) Pub. No.: US 2007/0258418 A1
(43) Pub. Date: Nov. 8, 2007

(54) Method and system for controlling streaming of media to wireless communication devices

(75) Inventors: Andrew M. Wurtenberger, Olathe, KS (US); Ryan S. Talley, Olathe, KS (US); Kristin Hayne, Overland Park, KS (US); Rajveen Narendran, Olathe, KS (US); Jeff Sopha, Olathe, KS (US)

Correspondence Address: SPRINT, 6391 SPRINT PARKWAY, KSOPHT0101-Z2100, OVERLAND PARK, KS, 66251-2100, US

(73) Assignee: Sprint Spectrum L.P., Overland Park, KS (US)

(21) Appl. No.: 11/417,436

(22) Filed: May 3, 2006

(51) Int. Cl. H04Q 7/24

(52) U.S. Cl. 370/338

(57) ABSTRACT

A method and system for controlling a streaming media session in which a media server streams media to a wireless communication device via a radio access network. The radio access network controls the streaming media session by (i) generating a media control signal based, at least in part, on an air interface state between the radio access network and the device and (ii) sending the media control signal to the media server. By sending the media control signal, the radio access network enables adjustment of at least one parameter of the streaming media session. Further, the radio access network may send the media control signal when prompted by the media server.

### FIELD OF THE INVENTION

The present invention relates to wireless communications and more particularly to controlling, at a radio access network, streaming media sessions in which media is streamed from media servers to wireless communication devices.

### DESCRIPTION OF RELATED ART

The art and popularity of wireless communications has grown significantly over recent years. Indeed, many millions of people are engaging in voice and data communications over wireless communication devices such as cellular telephones, Personal Digital Assistants (PDAs), and wirelessly-equipped computers. In principle, a user can communicate over the Internet or call anyone over the public switched telephone network (PSTN) from virtually anywhere within the coverage area of a cellular wireless network.

Most recently, one area of particular growth has been the streaming of real-time media such as video and audio content to wireless communication devices. Cell phones, PDAs, and other wireless devices that are equipped with streaming media clients can engage in wireless packet data communication. Such wireless devices can interact with streaming media servers in much the same way that landline personal computers have done for years, engaging in streaming media sessions to receive assorted real-time media content. Advantageously, however, wireless communications enable users to receive and enjoy such streaming media content without being tethered to a desk or another fixed location.

Advanced “multi-media” cell phones, for instance, now provide media player applications through which a user can select from a number of streaming media channels much like radio or television stations. When a user selects a desired streaming media channel, the media player may then send a session request to a designated media server and, after receiving session description parameters (e.g., codec, bit rate, etc.) from the server, the media player may begin receiving and presenting the requested media stream to the user.

By definition, the act of streaming media in real-time to a wireless communication device necessarily involves streaming the media over an air interface from a base station to the device. Unfortunately, however, the air interface between the base station and the device can sometimes function as a bottleneck, limiting the rate at which data can actually be transmitted to the device. This limitation can result from the finite quantity of radio resources that the typical base station must allocate among possibly many devices, and from a number of other factors. Further, the extent to which the typical air interface limits actual data rate of transmissions to wireless devices can vary over time due to assorted changes in the air interface, such as changes caused by varying proximity between a base station and wireless device, the number of devices being served by the base station, or changes in landscape or weather.

For non-real-time communications such as e-mail and web-page downloads, data-rate limitations imposed by the air interface are not a significant problem, since such data reaches the end user in bulk. For streaming media such as video and audio transmissions, however, the data-rate limitation can pose a problem. In particular, if a media server is streaming media to a client device at an agreed data rate but the media stream arrives at the client device at a slower rate, the media played out to the end user may appear choppy or otherwise distorted. Further, variations in the data rate due to changes in the air interface can cause additional distortion of the media.

Some attempts have been made to optimize streaming media in radio access networks. However, the prior art generally involves control of streaming media by the wireless communication device. As an example, a cell phone engaged in a streaming media session with a media server can monitor its network conditions, and if necessary, instruct the media server to reduce or increase the streaming data rate. While such technology improves the quality of streaming media, it requires costly modification of wireless communication devices. Consequently, improvement is desired.

### SUMMARY

The present invention is directed to a method and system for controlling, at a radio access network, the streaming of media to wireless communication devices. As disclosed herein, when a wireless communication device is in a streaming media session with a media server, a radio access network that is serving the device will engage in control communication with the media server to enable adjustment of session parameters.

Preferably, the radio access network will receive from the device, one or more indications of the air interface state, or messages of the type that are normally used by the radio access network to monitor the air interface or air-link conditions. With such indications or messages, the radio access network will have a record of the air-link conditions actually perceived by the device. During the streaming media session (or perhaps upon initiation of the session), the media server may query the radio access network to obtain information about the device's air-link conditions, and the radio access network may respond accordingly with an indication of the air-link conditions. Alternatively, the radio access network may autonomously report the device's air-link conditions to the media server. In either case, once the media server receives an indication of air-link conditions from the radio access network, the media server may then set or adjust the rate at which it streams media to the device.

More specifically, the invention provides a method for controlling a streaming media session in which a media server streams media to a wireless communication device via a radio access network, wherein the radio access network serves the wireless communication device via an air interface, and wherein the air interface defines an air interface state, the method comprising: (i) at the radio access network, generating a media control signal based, at least in part, on the air interface state, and (ii) sending the media control signal from the radio access network to the media server, in order to enable adjustment of at least one parameter of the streaming media session. Further, generating the media control signal may involve identifying the air interface state of the streaming media session.

In addition, a system is provided for controlling a streaming media session in which a media server streams media to a wireless communication device via a radio access network, wherein the radio access network serves the wireless communication device via an air interface, and wherein the air interface defines an air interface state associated with the streaming media session. The system comprises a radio access network that includes program logic for: (i) generating a media control signal based, at least in part, on the air interface state associated with the streaming media session and (ii) sending the media control signal from the radio access network to the media server to enable adjustment of at least one parameter of streaming media session. In an exemplary embodiment, the system may be implemented in an radio network controller or a base station, or both, as well as in other elements of the radio access network. Further, the radio network controller may generate the media control signal in response to a control request received from the media server.

To identify the air interface state associated with the streaming media session, the radio access network may use indications of air-link conditions that are routinely provided by the device. Specifically, the network may use the supportable data-rate for the air interface as an indicator of air interface conditions. The supportable data-rate can be routinely reported by the device in a radio access network providing wireless packet-data connectivity under industry standard IS-856, or EVDO protocol. Of importance, the radio access network can monitor air-link conditions using existing network infrastructure. Thus, the radio access network can monitor air-link conditions, and if necessary, adjust the data-rate of a session without modification to existing wireless communication devices. These, as well as other aspects, advantages, and alternatives, will become more apparent to those of ordinary skill in the art by reading the following detailed description.

### BRIEF DESCRIPTION OF THE DRAWINGS

FIG. 1 is a simplified block diagram depicting a radio access network in which an exemplary embodiment of the invention can be employed.

FIG. 2 is signal flow diagram depicting signal flow between radio access elements in an exemplary embodiment of the invention.

FIG. 3A is a flow chart illustrating a method for controlling streaming media in a radio access network in accordance with an exemplary embodiment of the invention.

FIG. 3B is another flow chart illustrating a method for controlling streaming media in a radio access network in accordance with an exemplary embodiment of the invention.

FIG. 4 is another simplified block diagram depicting a radio access network in which an exemplary embodiment of the invention can be employed.

FIG. 5 is signal flow diagram depicting signal flow between radio access elements in an exemplary embodiment of the invention.

### DETAILED DESCRIPTION

In a radio access network (“RAN”), an area is divided geographically into a number of cells, each defined by a radio frequency (“RF”) radiation pattern from a respective base transceiver station (“BTS”) antenna. Each cell may be further divided into a number of sectors. When a wireless communication device (“WCD”) (such as a cellular telephone, pager, or appropriately equipped portable computer, for instance) is positioned in a cell in a radio access network, the WCD communicates via an RF air interface with the BTS antenna of the cell. Consequently, a communication path is established between the WCD and the transport network, via the air interface, the BTS, the radio network controller (“RNC”, or sometimes referred to as a base station controller or “BSC”) and a network switch or gateway.

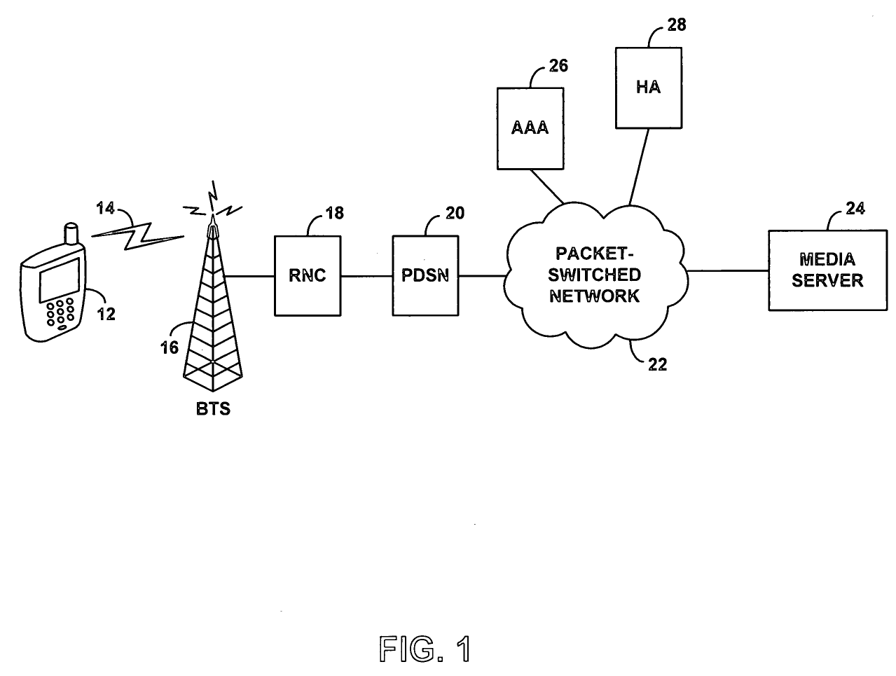

FIG. 1 depicts an exemplary RAN adapted to provide wireless packet-data communication service for a WCD 12. WCD 12 communicates over an air interface 14 with a BTS 16, which is then coupled or integrated with an RNC 18. RNC 18 is then coupled with a Packet-Data Serving Node (“PDSN”) 20, which provides connectivity with a packet-switched network 22 such as the Internet and/or a wireless carrier's private core packet-network. In addition, RNC 18 may include a packet control function (“PCF”), for controlling packet-data communications. Sitting as nodes on network 22 are, by way of example, a media server 24, an authentication, authorization, and accounting (“AAA”) server 26, and a mobile-IP home agent (“HA”) 28.

To establish packet-data communications, WCD 12 may send a request for a channel assignment via BTS 16, RNC 18, PDSN 20, and network 22, to AAA server 26. Then after AAA server 26 authenticates WCD 12, HA 28 may assign an IP address for use by WCD 12. WCD 12 may then engage in packet-data communications with entities such as media server 24, via a communication path comprising air interface 14, BTS 16, RNC 18, PDSN 20, and network 22. Further, the PCF of RNC 18 may regulate packet flow through the RAN to WCD 12. As such, the PCF may allow the RNC to access and extract data and information from packet-data communications established via the RNC.

Communications over an air interface are typically divided into forward link communications, which are those passing from the base station to the WCD, and reverse link communications, which are those passing from the WCD to the base station. In addition, WCD 12 may communicate over air interface 14 under various air interface protocols. As an example, WCD 12 may engage in packet-data communications using a high rate packet data (“HRPD”) system, which can be defined by industry standard IS-856 (sometimes referred to as “EVDO”).

IS-856 leverages the asymmetric characteristics of most IP traffic, in which the forward link typically carries a heavier load than the reverse link. Under IS-856, the forward link uses time division multiplexing (“TDM”), in order to allocate all power in a sector to a given user at any moment, while the reverse link primarily retains the industry standard IS-2000 code division multiplexing (“CDM”) format, albeit with the addition of a data rate control (“DRC”) channel. The end result is that a WCD operating under IS-856 can, in theory, receive packet-data at a rate of at least 38.4 kbps and up to 2.4 Mbps. Further, using minimal network resources, the DRC channel can indicate to the RAN, the supportable data rate for the forward link.

To acquire packet data connectivity under IS-856, after a WCD 12 first detects an IS-856 carrier, WCD 12 sends to its RNC 18 a Universal Access Terminal Identifier (“UATI”) request, and receives in response an International Mobile Station Identifier (“IMSI”), which the WCD 12 can then use to identify itself in subsequent communications with the RNC 18. The WCD 12 then sends a connection-request to the RNC 18, and the RNC 18 responsively invokes a process to authenticate WCD 12 and to have the WCD acquire a data link.

In particular, the RNC 18 sends an access request to an Access Network AAA (“ANAAA”) server (which may be different than the AAA server 26 shown in FIG. 1), and the ANAAA server authenticates WCD 12. The RNC 18 then assigns radio resources for the data session, by directing WCD 12 to operate on a particular time slot traffic channel on the forward link and a particular Walsh coded traffic channel on the reverse link. Further, the RNC 18 signals to the PDSN 20, and the PDSN and WCD 12 then negotiate to establish a PPP data link. WCD 12 then sends a Mobile-IP Request to PDSN 20, which the PDSN forwards to the HA 28, and the HA assigns a mobile-IP address for the WCD to use. Once WCD 12 acquires a mobile-IP address, the WCD can engage in packet-data communications.

Utilizing packet-data connectivity, a WCD may engage in a streaming media session. A streaming media session may involve a media server 24 sending data, such as a media file, to WCD 12 in real-time. When media is sent in real-time, the WCD plays the media file as the file is received, rather than waiting to receive the entire media file before initiating playback. In some real-time sessions, the WCD may utilize a buffer, pre-loading a portion of the media as a preventative measure, should network conditions become less favorable. Media files that can be streamed include files formatted for audio-visual, auditory or textual display, as well as other types of media files and/or formats. The media may be streamed using the industry standard Real-time Transport Protocol (“RTP”—Internet Engineering Task Force (“IETF”) Request for Comments (“RFC”)3550), or may be streamed by other methods.

A streaming media session can be controlled or monitored using Real-time Streaming Protocol (“RTSP”). RTSP can be used to control a streaming media session, learn and report characteristics or parameters of the session, and/or for other purposes. RTSP allows for two-way communication between a “client,” the entity controlling the streaming media session (but not necessarily the entity receiving the media), and a “server,” the entity streaming the media. Therefore, both the client and the server can send each other RTSP “messages” or “requests,” as well as “responses.” RTSP messages may be formed using Session Description Protocol (“SDP”). Another important aspect of RTSP messaging is that the client controlling the session need not be the entity receiving the streaming media. Thus, one network entity could serve as a controller for a streaming media session between a server and another network entity.

RTSP can be used to control a streaming media session regardless of the protocols or standards used to establish the session or stream the media. For example, RTSP can control streaming media being transferred under RTP. As another example, RTSP may be used to control session created under Session Initiation Protocol (“SIP”), although generally, a streaming media session controlled by RTSP will also be initiated using RTSP. The core industry standards for SIP (IETF RFC 3853) and RTSP (IETF RFC 2326) are hereby incorporated by reference.

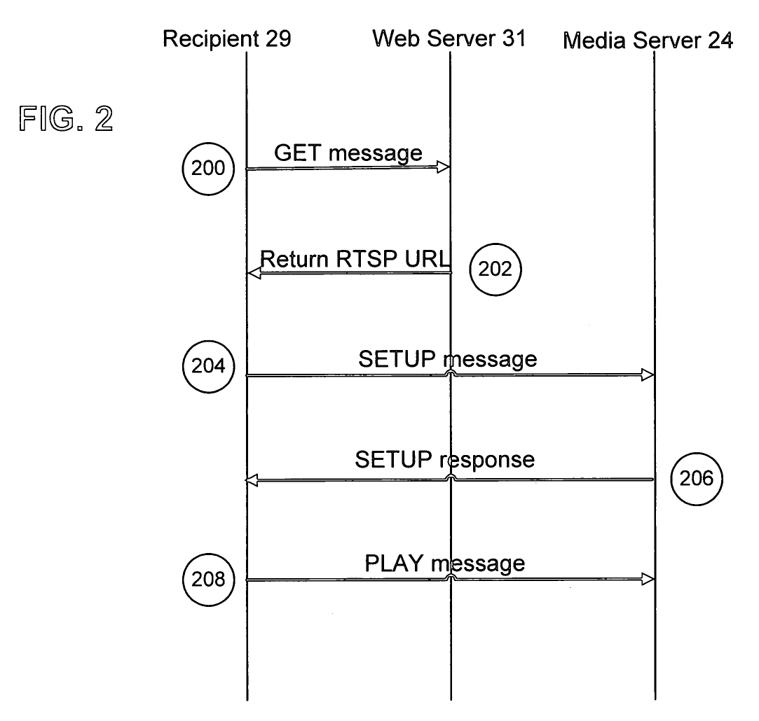

FIG. 2 shows an exemplary RTSP signal flow for initiating a streaming media session. An entity initiating a session must specify content to be streamed. The location of content available for streaming can be referred to by a RTSP URL. Therefore, to initiate a session, recipient 29 may locate a media file by sending an RTSP GET request 200 to a web server 31 that provides RTSP URLs. The web server 31 may then send an RTSP response 202 to the recipient 29, which includes an RTSP URL for the requested content. Next, the recipient 29 can send an RTSP SETUP message 204 to the RTSP URL provided by web server 31. In the event the content is stored on a media server 24, the media server may send recipient 29 a SETUP response 206 describing parameters or characteristics of the session. In particular, the response may include a session identifier, uniquely identifying the streaming media session.

After a successful SETUP request, recipient 29 may send an RTSP PLAY message 208 to media server 24 to initiate the streaming media session. The PLAY request may include a session-ID, associating the particular streaming media session with recipient 29 (as the same media may be streamed to multiple clients, resulting in multiple sessions). Upon receiving the PLAY request, media server 24 begins sending the media specified by the RTSP URL to recipient 29. Once the session is established, the recipient, which may be a WCD 12, or any other authorized network entity, such as RNC 18, can control the session by sending RTSP messages to media server 24.

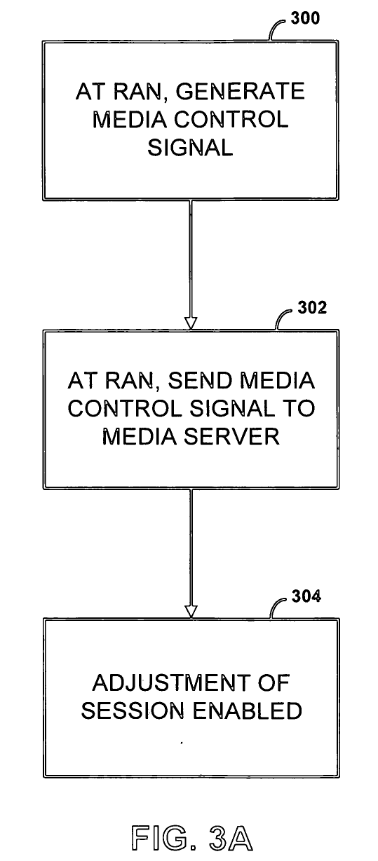

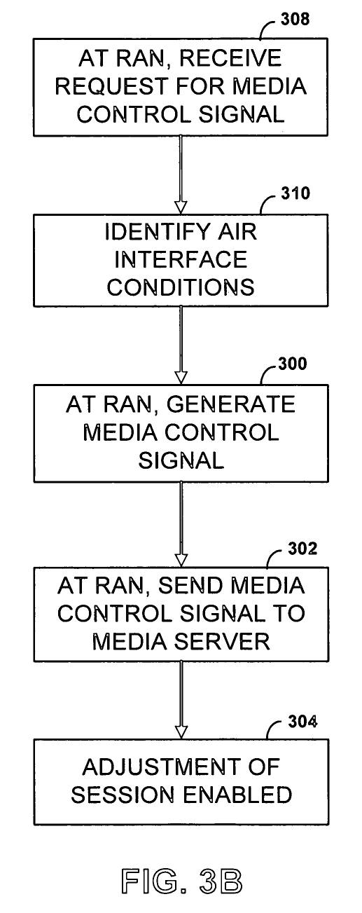

FIG. 3A shows an exemplary method for controlling a streaming media session in which a media server streams media to a WCD via a RAN. The method is carried out primarily by the RAN, or by elements of the RAN. Initially, the RAN generates a media control signal (“MCS”) based, at least in part, on the air interface state between the RAN and the WCD, as shown in step 300. For example, the RAN may generate a media control signal that includes the bandwidth available to the WCD. Then, in step 302, the RAN sends the MCS to the media server. By sending the MCS to the media server, the RAN enables adjustment of at least one parameter of the session, as shown in step 304.

Sending the media control signal to the media server may enable adjustment of the session in various ways. For example, the RAN may translate air interface conditions into a form understandable by the media server. The translated air interface conditions can then be included in an MCS, thereby allowing the media server to analyze the air interface conditions and adjust parameters of the session accordingly. In particular, the media control signal may provide an indication of the available bandwidth for the session, allowing the media server to adjust the bit rate at which the server streams the media. Alternatively, the RAN itself might analyze the air interface conditions, and send a media control signal explicitly instructing the media server to adjust a parameter of the session. As an example, the media control signal might include instructions for streaming media at a specific bit rate. Other examples are possible as well.

FIG. 3B depicts another exemplary method for controlling a streaming media session in which a media server streams media to a WCD via a RAN. In FIG. 3B, the method is initiated when the RAN receives a control request, prompting the RAN to generate and send an MCS, as shown in step 306. In the exemplary embodiment, the control request may be sent by the media server. However, the request can originate from any source. The RAN then identifies the air interface state between the RAN and the WCD, as shown in step 308. Then, using the identified air interface state, the RAN generates a media control signal, as shown in step 300. Next, in step 302, the RAN sends the MCS to the media server, which enables adjustment of the session, as shown in step 304.

The RAN may receive one or more control requests from the media server during the course of a streaming media session. In an exemplary embodiment, the media server may periodically send control requests to the RAN. Alternatively, the media server may detect a state of the session that prompts it to send a control request, or may send a control request for any other reason. A control request can provide the RAN information for use in generating and sending an appropriate media control signal back to the media server.

More specifically, a control request may include a WCD-ID identifying the wireless communication device participating in the streaming media session. The WCD-ID may be an IP-address, UATI, or IMSI assigned to the WCD when the WCD established a network connection, or the WCD-ID may take other forms. Further, the request may include a session identifier (“session-ID”), uniquely identifying the streaming media session for which the request is sent. Yet further, the request may include an identifier for the media server, such as the media server's URL or RTSP URL. A control request might also detail the type of MCS desired. For instance, the media server might call for an MCS including the available bandwidth. Alternatively, the RAN might default to generating an MCS in a predetermined format.

The RNC may generate a media control signal in response to a control request. Alternatively, the RNC might generate an MCS automatically or generate an MCS in response to some predefined stimuli, for example, a change in the air interface state. To illustrate, a control request might not specify anything more than the session-ID and the streaming data-rate. Consequently, the RAN might automatically compare the streaming data-rate to the available bandwidth and send an MCS with instructions corresponding to the comparison. Other triggers for generating a media control signal are possible as well.

The media control signal is based, at least in part, on the air interface state or air-link quality, between the RAN and the WCD. Thus, the MCS may include a description of the air interface state, such as the bandwidth available over the assigned the channel. The RAN may also include a WCD-ID and/or session-ID in an MCS. The media server may require the session-ID or WCD-ID to identify the session referenced by the MCS. Further, the MCS may include other information indicative of the air interface state and/or instructions for adjusting a parameter (or parameters) of the session. The MCS may be of any format and can be determined by engineering design choice.

In some exemplary embodiments, the MCS may take the form of an RTSP message or messages. More specifically, once a streaming media session is established between WCD and a media server, the RAN may use RTSP messages to adjust the session when necessary. Thus, the RAN may generate an RTSP message based on the air interface state between the RAN and the WCD, and then send the message to media server.

In particular, the RAN may use the RTSP SET_PARAMETER messages to enable adjustment of the session by the media server. To use the SET_PARAMETER messages, the optional field “Air-Interface-State,” may be defined at both the media server and the RAN. Thus an RTSP command for enabling adjustment of the streaming bit rate could be:

SET_PARAMETER rtsp://examplemediaserver.com/mediafile RTSP 1.0

Cseq: 9

Content-type: text/parameters

Air-Interface-State: 128000

The format and methods for creating such RTSP messages are generally known in the art. Here, the optional Air-Interface-State field could indicate that 128 kbps are available for the session, or might indicate that the media server should stream media at 128 kbps, or both. Once the media server receives the SET_PARAMETER message, the media server could compare the bandwidth available with the current streaming data rate, and if necessary, adjust the streaming data rate.

The RTSP OPTION message could also be used in a similar manner to communicate the air interface state to the media server. Specifically, an OPTION message could be created having the similar parameters to the above described SET_PARAMETER message, including the optional Air-Interface-State field. However, unlike a SET_PARAMETER message, an OPTION message does not necessarily instruct the media server to adjust a parameter of the session. Rather, an OPTION message can simply provide the air interface state to the media server. The media server could then make the determination whether or not to adjust a parameter of the session.

As an alternative, the RAN might send an RTSP PAUSE request immediately followed by a RTSP PLAY message. The PLAY message includes a standard “Speed” option, which indicates the data rate at which the server should stream the requested file. However, when a server receives multiple PLAY messages, it queues the messages, finishing each PLAY request before processing the next. Therefore, sending a PLAY request will not automatically update the streaming data rate. However, if a PAUSE message is sent, the server waits for the next PLAY request to resume streaming. Thus, a PAUSE message, followed immediately by a PLAY message with a new bit rate, can successfully change the streaming rate. This embodiment is advantageous as it does not require defining optional fields, and allows the comparison of available versus current streaming data rate to occur at the RAN. On the other hand, the PAUSE message, true to its name, pauses the streaming media session, which could result in flawed real-time playback. In actuality however, most streaming sessions, incorporate a buffer, so the effect of the PAUSE message may be negligible.

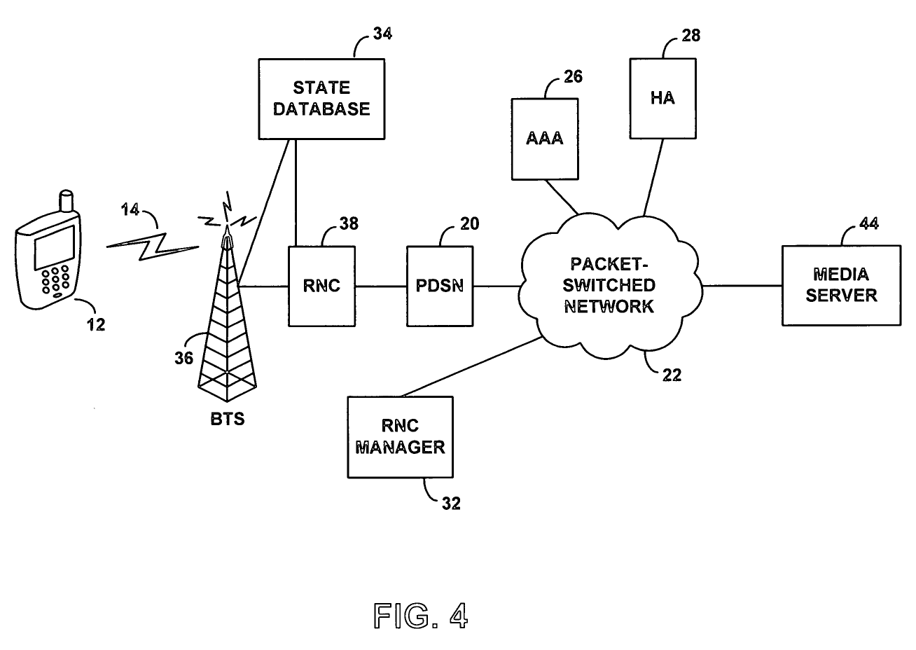

FIG. 4 shows an exemplary system for controlling a streaming media session in which a media server streams media to a WCD via a RAN. FIG. 4 is similar to FIG. 1, but includes an RNC manager 32 and an air interface state database 34. FIG. 3 also includes a BTS 36, RNC 38, and media server 44. BTS 36 may function to identify the air interface state of air interface 14. Further, BTS 36 may, from time to time, store the air interface state in a state database 34. Media server 44 may function to send a control request to RNC 38 via the packet switched network 22 and PDSN 20. In order to send the control request, media server 44 may query the RNC manager 32 to determine which RNC is serving WCD 12. RNC 38 may function to populate the RNC manager 32 with a list of WCDs being served by RNC 38. In addition, RNC 38 may include or have access to the state database 34, from which RNC 38 can retrieve the air interface state of air interface 14. RNC 38 can then use the air interface state to generate and send a media control signal to media server 44.

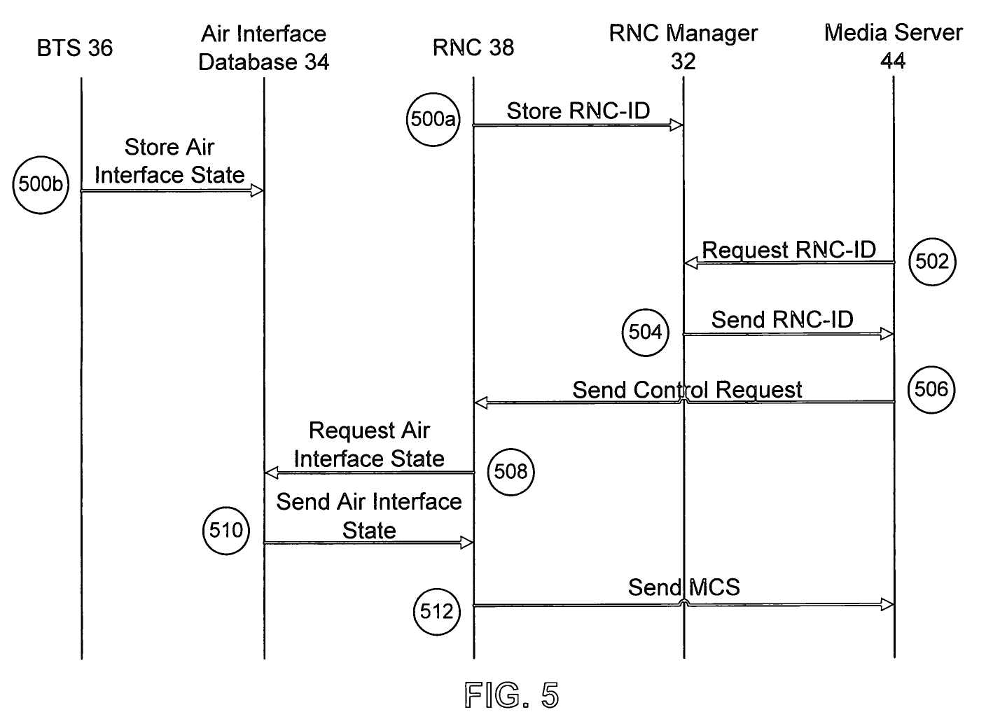

FIG. 5 depicts an exemplary signal flow in the system of FIG. 4. The signals carry out various processes, including, among others, (1) regularly maintaining information that the RAN can use to generate and send an MCS from RNC 38 to media server 44, (2) receiving, at RNC 38, a control request from media server 44, and (3) at RNC 38, responding to the control request by generating and sending an MCS to the media server 44.

Signals 500a and 500b may be sent regularly in order to maintain data for the operation of the system. Specifically, signals 500a and 500b may populate RNC manager 32 and maintain air interface state database 34, respectively. Signal 500a is sent from RNC 38 to RNC Manager 32 to store an identifier of the RNC (“RNC-ID”), indicating that the RNC is serving WCD 12. Signal 500b is sent from BTS 36 to air interface state database 34 to store the air interface state. These signals, 500a and 500b, need not be sent in any particular order or at any particular time, so long as RNC manager 32 and air interface state database 34 are updated regularly. When and how frequently RNC manager 32 and state database 34 are updated, are matters of engineering design choice.

Signals 502-506 carry out the process of sending a control request from media server 44 to RNC 38. Initially, the media server may not know which RNC serves a WCD. In order to locate the RNC that is serving WCD 12, media server 44 may retrieve an RNC-ID for RNC 38 from RNC manager 32, a process carried out by signals 502-504. Then, media server 44 sends a control request 506 to RNC 38. RNC 38 can then retrieve the air interface state between media server 44 and WCD 12 from the state database 34, a process carried out by signals 508-510. RNC 38 can then use the air interface state to generate and send a media control signal 512 to the media server 44.

Returning to FIG. 4, air interface state database 34 can provide, for at least each WCD 12 communicating via the RNC 38, the air interface state between the RAN and the WCD. For example, an entry in state database 34 for WCD 12 may include the state of air interface 14, or possibly a history of the state of air interface 14. More specifically, the air interface state might include a bit-rate or data-rate indicative of the bandwidth available over air interface 14. Provided with access to state database 34, RNC 38 can retrieve the air interface state by querying the state database 34 with a WCD-ID.

BTS 36 may include program logic for maintaining air interface state database 34. Specifically, BTS 36 may periodically, or from time to time, store the air interface state of air interface 14 in air interface state database 34. BTS 36 may, as a matter of course, receive indications of air-link quality from WCD 12, which the BTS can use to identify the air interface state. The BTS can then store an indicator of the air interface state, along with a WCD-ID for WCD 12, in air interface state database 34.

Conveniently, in existing EVDO networks, WCDs automatically report air-interface conditions of the forward link to their serving BTS. To report conditions, WCDs utilize the DRC channel. In particular, WCD 12 can send indications of the supportable data-rate to BTS 36 over the DRC channel, or can send indicators of air interface conditions in other forms. The supportable data-rate indicates the bandwidth available to WCD 12 over the forward-link of air interface 14. The indicators of air-interface conditions can be used by a BTS to determine the air interface state.

BTS 36 may also include program logic for using an indication, or series or indications, of the supportable data-rate to identify the air interface state. For example, BTS 36 may determine the air interface state by averaging the supportable data rate over a predetermined period of time, or by other means. As another example, BTS 36 may simply store the supportable data rate in a form understandable by the RNC 38.

In an alternative embodiment, BTS 36 may include program logic for sending the air interface state directly to RNC 38. In this embodiment, RNC 38 may include program logic for determining the air interface state from reported air interface conditions and storing states in state database 34. Therefore, RNC 38 can retrieve the air interface state, when required to generate an MCS. As an alternative, RNC 38 may include program logic for immediately using the air interface state to generate an MCS. As yet another alternative, RNC 38 may request the air interface state from BTS 36 when the air interface state is required for generating an MCS. Upon receipt of the request, BTS 36 may send the air interface state to RNC 38, or store the air interface state in the state database 34, where the state can be accessed by RNC 38. Other examples are possible as well.

In order to identify the RNC serving a particular WCD, RNC manager 32 may contain, for each RNC, a list of the WCDs being served by the RNC. RNC manager 32 may be maintained collectively by one or more RNCs, or by a single RNC. In order to populate RNC manager 32, RNC 38 may signal to RNC manager 32 each time a WCD 12 establishes packet-data connectivity via RNC 38. In particular, RNC 38 may send its own identifier and/or an identifier of WCD 12, the WCD establishing the session. The identifier of RNC 38 may be the IP-address assigned to RNC 38, or may take other forms. The identifier of WCD 12 may the IP-address, UATI, and/or IMSI assigned to the WCD, or may take other forms. As discussed earlier, the RNC has access to the IP-address assigned a WCD, as well as the UATI and IMSI identifying the WCD, when the WCD is establishing packet-data connectivity via the RNC. In particular, RNC 38 may use its PCF to extract the WCD-ID, or learn the WCD-ID by other means.

Provided with access to RNC manager 32, a network entity can determine which RNC is serving a particular WCD. In an exemplary embodiment, a media server 44 that is engaged in a session with WCD 12, can query RNC manager 32 with the WCD-ID of WCD 12, and in response, receive the RNC-ID of RNC 38. For example, media server 44 may query RNC manager 32 with the IP-address assigned to WCD 12. In response, RNC manager 32 may send the media server the IP-address of RNC 38. Alternatively or additionally, the RNC manager may send the UATI or IMSI for the WCD, or other information. With the identifier of RNC 38, media server 44 can send a control request to RNC 38.

RNC 38 can generate an MCS by comparing the air interface state to the parameters of a streaming media session, and if necessary, including an instruction for adjusting a session parameter in the MCS. Alternatively, the RNC might determine the air interface state is such that adjustment is not required. As described earlier, the parameters of the session may be provided for RNC 38 in a control signal request, or from other sources. As a specific example, a control request from media server 44 may include the data rate at which media server 44 is streaming media to WCD 12. As previously explained, the air interface state may describe a supportable data rate for the channel assigned to the WCD 12. Therefore, RNC 38 can compare the supportable date rate to the data rate at which media server 44 is streaming media to WCD 12. RNC 38 can then generate an MCS including the results of this comparison, or with instructions dictated by the comparison, and send the MCS to media server 44.

By sending the MCS to media server 44, RNC 38 enables adjustment of the streaming media session. For example, if the supportable data rate is less than the streaming data rate, the MCS can instruct the media server to decrease the streaming data rate. On the other hand, if the supportable data rate is greater than the streaming data rate, the MCS can instruct the media server to increase the data rate. The media server may adjust the data rate by changing the frame rate, resolution and/or the codec of streaming media, or by other means. Alternatively, when additional bandwidth is available, the MCS can simply notify the media server of the available bandwidth. The media server can then determine whether or not a particular streaming session can make use of additional bandwidth, or if using additional bandwidth is unnecessary. In an alternative embodiment, the RNC may simply include the air interface state, or indications of the air interface, in the MCS. The media server can then compare the air interface state to the current streaming data rate, and, if necessary, adjust the streaming data rate as described above.

In the exemplary system, the described functionality may be carried out by program logic included in elements of the RAN, as well as entities accessible via an IP-network. For example, in some described embodiments, an RNC includes logic for generating and sending an MCS, a BTS includes program logic for identifying the air interface state, and a media server includes program logic for sending control requests and using an MCS to adjust a parameter of the session. However, other elements of the RAN and/or IP-network may include program logic for the functionality described herein, as well as program logic for other functionality. For example, the functionality of identifying the air interface state and the functionality of generating and sending an MCS may be included in the same RAN element; the BTS or the RNC, for instance. Those skilled in the art will easily understand how to implement the described functionality in various arrangements.

Exemplary embodiments of the invention have been described above. Those skilled in the art will understand, however, that changes and modifications may be made to the embodiment described without departing from the true scope and spirit of the invention, which is defined by the claims.

We claim:

1. A method for controlling a streaming media session in which a media server streams media to a wireless communication device via a radio access network, wherein the radio access network serves the wireless communication device via an air interface, and wherein the air interface defines an air interface state, the method comprising:
(i) at the radio access network, generating a media control signal based, at least in part, on the air interface state; and
(ii) sending the media control signal from the radio access network to the media server to enable adjustment of at least one parameter of the streaming media session.

2. The method of claim 1, further comprising periodically repeating steps (i) and (ii).

3. The method of claim 1, wherein generating the media control signal comprises identifying an air interface state associated with the session.

4. The method of claim 3, wherein identifying the air interface state associated with the session comprises receiving one or more indicators of the air interface state from the wireless communication device.

5. The method of claim 4, wherein identifying the air interface state associated with the session further comprises storing the one or more indicators of the air interface state associated with the session.

6. The method of claim 5, wherein generating the media control signal based, at least in part, on the air interface state comprises retrieving the one or more indicators of the air interface state associated with the session.

7. The method of claim 4, wherein generating the media control signal based, at least in part, on the air interface state further comprises using the one or more indicators of the air interface state as a basis for generating the media control signal.

8. The method of claim 3, wherein identifying the air interface state comprises, at the radio access network:
receiving a plurality of indicators of the air interface state from the wireless communication device; and
determining an air interface quality by averaging a predetermined number of the received indicators of the air interface state.

9. The method of claim 8, wherein generating the media control signal based, at least in part, on the air interface state comprises using the air interface quality as a basis for generating the media control signal.

10. The method of claim 1, wherein generating the media control signal based, at least in part, on the air interface state comprises:
at a first radio access network element that is part of the radio access network, receiving, from the wireless communication device, one or more indicators of the air interface state associated with the session;
using the one or more received indicators of the air interface state as a basis for determining an air interface quality; and
sending a message from the first radio access network element, to a second radio access network element that is part of the radio access network, wherein the message includes the air interface quality.

11. The method of claim 10, further comprising, at the second radio access network element, using the air interface quality as a basis for generating the media control signal.

12. The method of claim 1, wherein generating the media control signal based, at least in part, on the air interface state comprises:
at a first radio access network element that is part of the radio access network, periodically receiving at least one indicator of the air interface state from the wireless communication device;
determining an air interface quality by averaging a predetermined number of the received indicators of the air interface state; and
sending from the first radio access network element, to a second radio access network element that is part of the radio access network, an air interface quality signal, wherein the air interface quality signal is based, at least in part, on the air interface quality.

13. The method of claim 1, further comprising, at the radio access network, prior to generating the media control signal, receiving a request to send the media control signal to the media server.

14. The method of claim 1, wherein the media server streams the media at a data rate, and wherein the at least one parameter of the streaming media session is the data rate.

15. A system for controlling a streaming media session in which a media server streams media to a wireless communication device via a radio access network, wherein the radio access network serves the wireless communication device via an air interface, and wherein the air interface defines an air interface state associated with the streaming media session, the system comprising:
a radio access network; and
program logic, at the radio access network, for (i) generating a media control signal based, at least in part, on the air interface state associated with the streaming media session and (ii) sending the media control signal from the radio access network to the media server to enable adjustment of at least one parameter of streaming media session.

16. The system of claim 15, further comprising program logic, at the radio access network, for identifying the air interface state associated with the session.

17. The system of claim 16, wherein the program logic for identifying the air interface state associated with the session comprises program logic for receiving, from the wireless communication device, at least one indicator of the air interface state associated with the session.

18. The system of claim 16, wherein the radio access network comprises:
a first radio access network element that is part of the radio access network and includes the program logic for identifying the air interface state associated with the session; and
a second radio access network element that is part of the radio access network and includes the program logic for (i) generating the media control signal based, at least in part, on the air interface state associated with the streaming media session and (ii) sending the media control signal from the radio access network to the media server to enable adjustment of the least one parameter of streaming media session.

19. The system of claim 18, wherein the first radio access network element is a base transceiver station, and wherein the second radio access network element is a radio network controller.

20. The system of claim 15, wherein the program logic for generating the media control signal comprises program logic for generating the media control signal in accordance with real-time streaming protocol.

21. The system of claim 15, wherein the radio access network further comprises program logic for receiving a request to send the media control signal to the media server.
